(19) United States
(12) Patent Application Publication
(10) Pub. No.: US 2018/0025162 A1
(43) Pub. Date: Jan. 25, 2018

(54) APPLICATION PROGRAM ANALYSIS APPARATUS AND METHOD

(71) Applicant: FASOO.COM CO., LTD., Seoul (KR)

(72) Inventors: Min Sik JIN, Seoul (KR); Jong Won YOON, Seoul (KR); Jong Hwan IM, Seoul (KR)

(21) Appl. No.: 15/646,693

(22) Filed: Jul. 11, 2017

(30) Foreign Application Priority Data
Jul. 19, 2016 (KR) 10-2016-0091496

(51) Int. Cl. G06F 21/57

(52) U.S. Cl. CPC G06F 21/577; G06F 2221/033

(57) ABSTRACT

Disclosed is an application program analysis apparatus comprising a first analyzer performing a dynamic analysis on an application program and extracting a method call graph, a model-view-controller (MVC) information extractor extracting MVC information from the method call graph, and a second analyzer generating an extended call graph by extending the method call graph based on the MVC information, the extended call graph being applied to an analysis of a source code of the application program. Using the application program analysis apparatus, it is made possible to analyze an application program using an MVC pattern, which has been difficult to analyze through the conventional static analysis, thereby complementing the security vulnerability of the static analysis.

### CLAIM FOR PRIORITY

This application claims priority to Korean Patent Application No. 2016-0091496 filed on Jul. 19, 2016 in the Korean Intellectual Property Office (KIPO), the entire contents of which are hereby incorporated by reference.

### BACKGROUND

### 1. Technical Field

The present disclosure relates to apparatus and method for analyzing an application program, and more particularly, to an application program analysis apparatus utilizing a dynamic analysis result obtained for an analysis target application program for a static analysis on the analysis target application program and a method for the same.

### 2. Related Art

An application program analysis may be roughly classified into a static analysis and a dynamic analysis. The static analysis refers to an analysis on a source code of an analysis target application program as it is, and the dynamic analysis refers to a process of executing a part of code constituting the analysis target application program or a process of analyzing malicious code during the execution of the part of the code.

The dynamic analysis techniques are used for various purposes such as memory management, thread bug detection, heap/stack overrun detection, and program profiling. These analysis techniques are provided in various forms such as an emulator and a process-level dynamic code analyzer depending on purpose and specific implementation method.

In the case of the static analysis, it is possible to cope with a case where the analysis is impeded by debugging detection or virtual environment detection. However, if an analysis target code is transformed, executable-compressed, or encrypted, the analysis target code should be restored before performing the static analysis. On the other hand, when performing the dynamic analysis due to the executable compression or code transformation, the analysis target code may be executed to create a restored code, and the restored code may be checked. Then, the restored code may be executed to identify malicious functions or analyze vulnerability of it, and the restored code may be analyzed based on the result of the additional execution.

That is, when the analysis target code is executable-compressed, encrypted, or transformed as including a debugging detection code, the executable-compressed, encrypted, or transferred code should be additionally analyzed before performing the analysis. Also, in the case that not a source code but an executable module or byte code is given the static analysis may not be utilized. Since such the static analysis is performed based on a given source code, there is a problem that a correct analysis becomes difficult in the case of a control flow through a library whose source code is not given.

### SUMMARY

Accordingly, exemplary embodiments of the present disclosure are provided to substantially obviate one or more problems due to limitations and disadvantages of the related art.

Exemplary embodiments of the present disclosure provide an application program analysis apparatus that utilizes a dynamic analysis result for a static analysis.

Exemplary embodiments of the present disclosure also provide an application program analysis method that utilizes a dynamic analysis result for a static analysis.

Technical objects of the present disclosure are not limited to the aforementioned technical objects and other technical objects which are not mentioned will be apparently appreciated by those skilled in the art from the following description.

In order to achieve the above-described objective, an aspect of the present disclosure provides an application program analysis apparatus comprising a first analyzer performing a dynamic analysis on an application program and extracting a method call graph; a model-view-controller (MVC) information extractor extracting MVC information from the method call graph; and a second analyzer generating an extended call graph by extending the method call graph based on the MVC information, the extended call graph being applied to an analysis of a source code of the application program.

The MVC information may include information on controller-view relationship.

The second analyzer may use the extended call graph to analyze a control flow of the application program.

The first analyzer may be a dynamic analyzer, and the second analyzer may be a static analyzer.

The second analyzer may comprise a code analysis part generating analysis information by analyzing the source code of the application program, and a method call graph extension part extending the method call graph by using the MVC information.

The MVC information extractor may recognize a MVC pattern from the method call graph, and identify controller methods and view methods called by a dispatcher servlet in the recognized MVC pattern.

The MVC pattern may be implemented using Spring or Struts framework library.

In order to achieve the above-described objective, another aspect of the present disclosure provides an application program analysis method comprising performing a dynamic analysis on an application program and extracting a method call graph; extracting MVC information from the method call graph; and generating an extended call graph by extending the method call graph based on the MVC information, the extended call graph being applied to an analysis of a source code of the application program.

The MVC information may include information on controller-view relationship.

The method may further comprise analyzing a control flow of the application program by using the extended call graph.

The method may further comprise generating analysis information by analyzing the source code and control flow of the application program.

The extracting MCV information may comprise recognizing a MVC pattern from the method call graph, and identifying controller methods and view methods called by a dispatcher servlet in the recognized MVC pattern.

The MVC pattern may be implemented using Spring or Struts framework library.

According to the embodiments of the present disclosure as described above, it is made possible to analyze an application program in which an MVC pattern is used, which has been difficult to analyze through the conventional static analysis, thereby complementing the security vulnerability of the static analysis.

### BRIEF DESCRIPTION OF DRAWINGS

Exemplary embodiments of the present disclosure will become more apparent by describing in detail exemplary embodiments of the present disclosure with reference to the accompanying drawings, in which:

FIG. 1 is a block diagram illustrating an application program analysis apparatus according to an embodiment of the present disclosure;

FIG. 2 is a diagram illustrating an application program analysis apparatus according to another embodiment of the present disclosure, and an analysis flow between the application program analysis apparatus and components thereof;

FIGS. 3A and 3B are diagrams illustrating MVC architecture patterns which can be applied to the present disclosure;

FIG. 4 is a diagram illustrating a flow of operations in components within the Spring framework which can be applied to embodiments of the present disclosure;

FIG. 5 is a conceptual diagram illustrating a concept of MVC information extraction according to an embodiment of the present disclosure;

FIG. 6 is a detailed block diagram illustrating a static analyzer according to an embodiment of the present disclosure; and

FIG. 7 is a sequence chart for explaining an application program analysis method according to an embodiment of the present disclosure.

### DESCRIPTION OF EXEMPLARY EMBODIMENTS

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. Also, descriptions of functions and constructions that are well known to one of ordinary skill in the art may be omitted for increased clarity and conciseness.

Throughout the drawings and the detailed description, the same reference numerals refer to the same elements. The drawings may not be to scale, and the relative size, proportions, and depiction of elements in the drawings may be exaggerated for clarity, illustration, and convenience.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Combinations of respective blocks in an accompanying block diagram and respective operations in a flowchart may be performed by application program instructions. These application program instructions can be mounted on a processor of a general purpose computer, a special purpose computer, or other programmable data processing equipment, and thus the instructions performed by the processor of the computer or other programmable data processing equipment generate a means for performing functions described in the respective blocks of the block diagram or the respective operations of the flowchart. To implement functions in a specific way, these application program instructions can be stored in a computer-usable or computer-readable memory capable of aiming for a computer or other programmable data processing equipment, so that the instructions stored in the computer-usable or computer-readable memory can also produce a manufactured item including an instruction means for performing functions described in the respective blocks of the block diagram or the respective operations of the flowchart.

In addition, each block or operation may indicate a part of a module, a segment or a code including one or more executable instructions for executing specific logical function(s). It should be noted that mentioned functions described in blocks or operations can be executed out of order in some alternative embodiments. For example, two consecutively shown blocks or operations can be performed substantially at the same time, or can be performed in a reverse order according to the corresponding functions.

Hereinafter, exemplary embodiments according to the present disclosure will be described in detail by referring to accompanying drawings. However, the exemplary embodiments according to the present disclosure may be changed into various forms, and thus the scope of the present disclosure is not limited to the exemplary embodiments which will be described. The exemplary embodiments are provided to assist the one of ordinary skill in the art. in gaining a comprehensive understanding of the methods, apparatuses, and/or systems described herein.

Hereinafter, preferred embodiments according to the present disclosure will be described in detail with reference to the accompanying drawings.

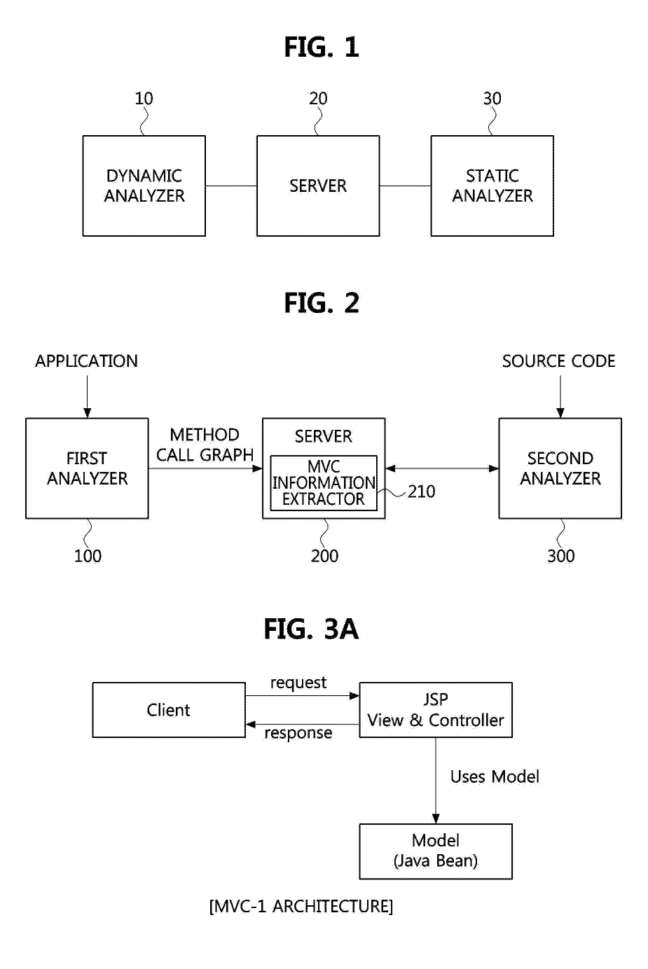

FIG. 1 is a block diagram illustrating an application program analysis apparatus according to an embodiment of the present disclosure.

As illustrated in FIG. 1, an application program analysis apparatus according to an embodiment of the present disclosure may comprise a dynamic analyzer 10, a server 20, and a static analyzer 30. Meanwhile, each of the dynamic analyzer 10, the server 20, and the static analyzer 30 may be a software module stored in a memory device or a storage device, and each of them may be executed by a processor. That is, the application program analysis apparatus may be implemented with a processor and a storage device storing instruction codes for the dynamic analyzer 10, the server 20, and the static analyzer 30. Also, the dynamic analyzer 10, the server 20, and the static analyzer 30 may exist in a single computing apparatus, or exist in two or more computing apparatuses in distributed manner.

The dynamic analyzer 10 may analyze a target application program using an analysis technique capable of tracking and debugging or profiling the target application program without affecting the target application program in operation. The dynamic analyzer 10 according to the present disclosure may provide the server 20 with a method call graph derived from such the dynamic analysis.

The server 20 may mediate the dynamic analyzer 10 and the static analyzer 30, and extract Model-View-Controller (MVC) information from the method call graph received from the dynamic analyzer 10. Here, the MVC information may include information that defines controller-view relationship by identifying controller methods and view methods called from a dispatcher servlet, which will be described later, in the method call graph.

The server 20 may also provide the MVC information to the static analyzer 30 in response to a request from the static analyzer 30.

The static analyzer 30 may analyze the target application program based on a static code analysis technique. That is, the static analyzer 30 may perform analysis on a source code of the target application program without directly executing the application program. Here, a static code analysis tool that is a program developed to automatically perform the static code analysis may be used. Usually, the size of the source code is very large, and it is almost impossible to manually perform the static code analysis. The static code analysis tool for the static code analysis may detect various kinds of defects or vulnerabilities in the source code according to a type of the tool, and provide the user with the defects detected through the analysis.

Usual static analysis makes it difficult to analyze a control flow of an application that contains a MVC pattern. Therefore, the static analyzer 30 according to the present disclosure may generate an extended call graph by extending the method call graph based on the MVC information received from the server 20, and perform analysis on the target application program.

FIG. 2 is a diagram illustrating an application program analysis apparatus according to another embodiment of the present disclosure, and an analysis flow between the application program analysis apparatus and components thereof.

As illustrated in FIG. 2, an application program analysis apparatus according to another embodiment of the present disclosure may comprise a first analyzer 100, a server 200, and a second analyzer 300. That is, the embodiment of FIG. 2 is a more specified embodiment than the embodiment of FIG. 1. As described above, each of the first analyzer 100, the server 200, and the second analyzer 300 may be a software module stored in a memory device or a storage device, and each of them may be executed by a processor. That is, the application program analysis apparatus may be implemented with a processor and a storage device storing instruction codes for the first analyzer 100, the server 200, and the second analyzer 300. Also, the first analyzer 100, the server 200, and the second analyzer 300 may exist in a single computing apparatus, or exist in two or more computing apparatuses in distributed manner.

The first analyzer 100 may analyze a target application program being executed and generate a method call graph.

A preferred embodiment of the first analyzer 100 may be the dynamic analyzer 10, but the type of the first analyzer 100 according to the present disclosure is not limited to the dynamic analyzer. The first analyzer 100 may collect method call information from the target application program during the dynamic analysis and generate the method call graph.

The target application program may contain various functions and/or methods needed to execute the target application program. If there are any functions and/or methods to analyze, these functions and/or methods consist of instructions. When a function or method is executed, the instructions may be loaded into a system memory in units of pages grouped by a certain number of these instructions. That is, the function and/or method may be executed in such a manner that the first page is first loaded into the system memory and executed, and then the second page, which is the next page, is loaded into the system memory and executed.

While the target application program is running, the method call graph may be used to represent an overview for profiling the application program. Here, the profiling may be required to understand behaviors of the application program and to detect errors or defects in the application program and its source code, and to analyze the performance of the application program.

The method call graph is a graph representing call relations between methods. Each method may be represented as a single node. In a case that a method (e.g., method A) has code that calls another method (e.g., method B), a directional graph may be represented by creating an edge connecting the methods A and B in the direction from the method B to the method A.

The method call graph generated by the first analyzer 100 may be transferred to the server 200, and the server 200 according to an embodiment of the present disclosure may comprise a MVC information extractor 210. The MVC information extractor 210 may extract MVC information using the method call graph. Here, the MVC information may include information on a control flow between controller and view.

Meanwhile, in the embodiment illustrated in FIG. 2, the MVC information extractor 210 is depicted as included in the server 200. However, the MVC information extractor 210 may be configured as included in the first analyzer 100 or the second analyzer 300. In this case, the application program analysis apparatus according to the present disclosure may not require a separate server. That is, the server 200 may be an optional component in the present disclosure. If the server 200 does not exist, the first analyzer 100 and the second analyzer 300 may communicate with each other directly.

The MVC information extracted by the MVC information extractor 210 may be transferred to the second analyzer 300, and the second analyzer 300 may extend the received method call graph by using the MVC information so that an extended call graph is generated.

A preferred embodiment of the second analyzer 300 may be the static analyzer 30, but the form of the second analyzer 300 according to the present disclosure is not limited to the static analyzer.

The second analyzer 300 may analyze the target application program based on a static code analysis technique. That is, the second analyzer 300 may perform analysis on a source code of the target application program without directly executing the application program. Here, a static code analysis tool that is a program developed to automatically perform the static code analysis may be used. Usually, the size of the source code is very large, and it is almost impossible to manually perform the static code analysis. The static code analysis tool for the static code analysis may detect various kinds of defects or vulnerabilities in the source code according to a type of the tool, and provide the user with the defects detected through the analysis.

In the present disclosure, noted is a case that the application program analyzed by the second analyzer 300 contains an MVC pattern. In the case of the MVC pattern, it is difficult to analyze a control flow between controller and view, which makes it difficult to analyze the application program. The second analyzer 300 may utilize controller-view relationship of the MVC pattern (i.e., the MVC information) to generate and analyze a control flow from controller methods to view methods.

Hereinafter, in order to facilitate understanding of the present disclosure, a MVC framework and a MVC architecture pattern will be described.

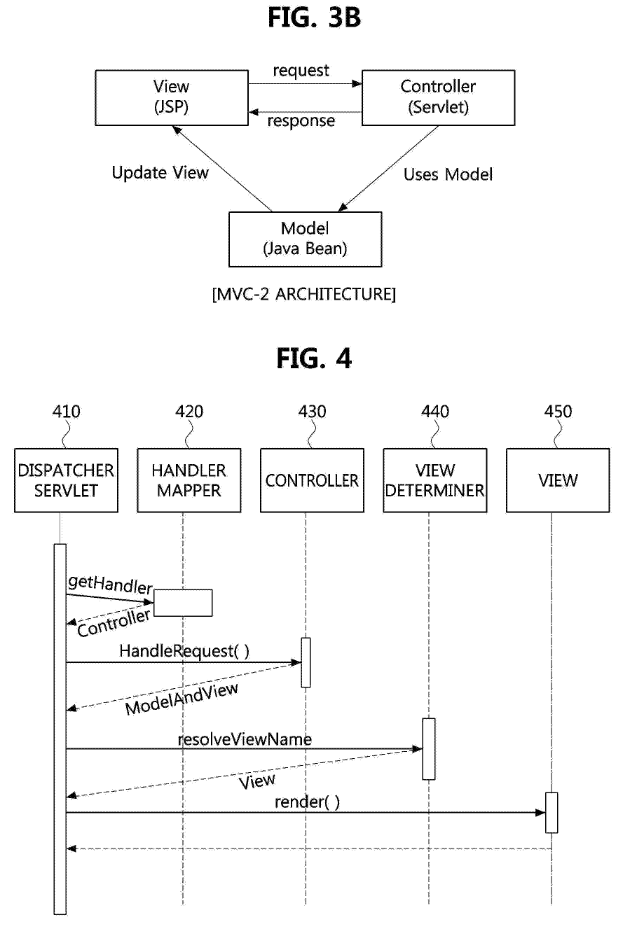

FIGS. 3A and 3B are diagrams illustrating MVC architecture patterns which can be applied to the present disclosure. FIG. 3A illustrates a first MVC architecture (MVC-1 architecture), and FIG. 3B illustrates a second MVC architecture (MVC-2 architecture).

Since the MVC pattern to which the present disclosure is applied is implemented using a framework library such as Spring or Struts, it is difficult to analyze a control flow from controller to view.

The Model-View-Controller (MVC) is a way to divide Java classes into model, view, and controller. That is, the MVC is an architecture pattern that makes screen and data processing separate and reusable.

As illustrated in FIGS. 3A and 3B, the MVC-1 architecture has a mixed form of the view and the controller, and the MVC-2 architecture has a form in which all requests basically call the controller. The MVC-2 architecture divides the areas of the developer and the publisher by separating the view and the controller, and controls the view through uniform resource identifier (URI).

On the other hand, the MVC framework library is designed to enhance the efficiency and maintainability of application program development. The typical MVC framework library for developing MVC patterns may include Struts, Spring, etc.

The Struts framework is designed and developed for front-end control of a web application and provides various functions for applications that interact with the user.

Also, the Spring framework is designed and developed for desktop and Internet-based applications. The Spring framework is designed to handle multiple tasks and uses a pattern called a front controller. In other words, the Spring Framework is a structure in which the front controller is placed in front of the controller, and the front controller receives all requests from users, and controls the entire flow. The controller handles only a subset of the entire logic through delegation.

Both the Struts framework and the Spring framework follow the MVC-2 architecture.

FIG. 4 is a diagram illustrating a flow of operations in components within the Spring framework which can be applied to embodiments of the present disclosure.

The MVC architecture according to the Spring framework may be configured with a dispatcher servlet 410, a handler mapper 420, a controller 430, a view determiner 440, a view 450, a model and view (not depicted), etc. FIG. 4 shows how these components make up the Spring framework.

The dispatcher servlet 410 located at the front end of the Spring framework is an entry point for the application program. When the dispatcher servlet 410 receives a request, it may determine a handler to process the request through the handler mapper 420, and the determined handler may call the controller. Then, the controller may execute the model and view.

More specifically, the dispatcher servlet 410 may serve as the front controller according to the Spring framework. That is, the dispatcher servlet 410 may receive all of incoming requests and control the entire flow of the application program.

The handler mapper 420 is a strategy interface used by the dispatcher servlet 410 to map the received requests to individual controllers. The handler mapper 420 may identify the incoming request and invoke an individual handler that provides the service corresponding to the incoming request.

The controller 430 is a user-generated element for processing requests, encapsulating a navigation logic representative into objects for business logic.

The model and view are integral parts according the Spring framework and implement the business logic of the application program. The model and view may be controlled by the controller, and store business logic and related views.

How the output to be displayed is displayed depends on the results received from the model and view, which the view determiner 440 is responsible for mapping a logical view name to an actual view implementation. That is, the view determiner 440 may identify and implement what an output media is and how to display it.

The view 450 may serve to render the output. Different views may be selected based on the results and various types of output for display devices or communication devices.

As describe above, MVC patterns may be represented by elements of models, views, and controllers.

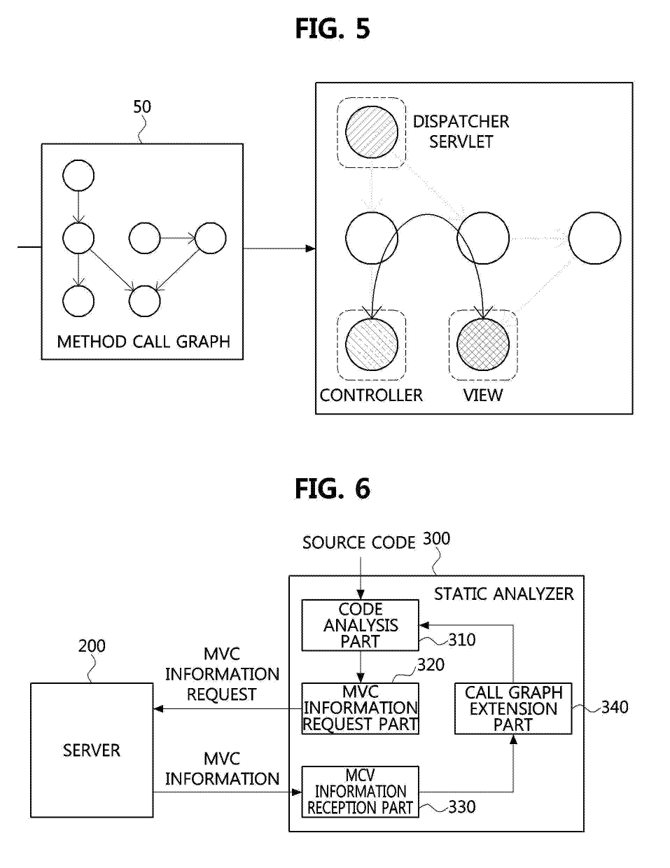

FIG. 5 is a conceptual diagram illustrating a concept of MVC information extraction according to an embodiment of the present disclosure.

In FIG. 5, a form of a method call graph 50 may be identified. As illustrated in FIG. 5, each of the methods may be represented by one node. When a first method has a code for calling a second method, the direction may be indicated by an edge connected from the second method to the first method.

In the application program analysis method according to the present disclosure, when the target application program uses an MVC pattern, the method call graph may be analyzed using the MVC framework. That is, if the application program is built using the MVC framework, the controller methods and view methods called from the dispatcher servlet, as illustrated in FIG. 5, may be identified from the method call graph of the application program, and MVC information defining controller-view relationship may also be obtained.

That is, the MVC information extractor according to the present disclosure may recognize a MVC pattern included in the method call graph, and identify the controller methods and the view methods called from the dispatcher servlet in the recognized MVC pattern. Here, the MVC pattern may be implemented using the Spring or Struts framework library as described above with reference to FIGS. 3 and 4.

FIG. 6 is a detailed block diagram illustrating a static analyzer according to an embodiment of the present disclosure.

The embodiment of FIG. 6 illustrates a case where the MVC information extraction is performed by the server 200. However, the MVC information extraction may be performed by the first analyzer 100 or the second analyzer 300 as described above.

The static analyzer 300 according to an embodiment of the present disclosure may receive a source code (or execution code) of a target application program, and generate static analysis information.

The static analysis information may include a control flow graph of the application program derived by analyzing the source code, information on variables to be used, event information, permission-related setting information, and the like.

The static analyzer 300 according to an embodiment of the present disclosure may comprise a code analysis part 310, an MVC information request part 320, an MVC information reception part 330, and a call graph extension part 340. Meanwhile, each of the code analysis part 310, the MVC information request part 320, the MVC information reception part 330, and the call graph extension part 340 may also be a software module constituting the static analyzer 300, which is stored in a memory device or a storage device, and executed by a processor.

The code analysis part 310 may analyze the source code of the target application program and generate analysis information. The analysis information may include a list of permissions related to information derivation and transmission. When the code analysis part 310 determines that the application program uses a MVC pattern, the code analysis part 310 may notify the MVC information request part 320 that the target application program uses the MVC pattern.

The MVC information request part 320 may receive the notification from the code analysis part 310 and request the server 200 for MVC information related to the application program. The MVC information reception part 330 may receive the MVC information extracted by the server 200.

The call graph extension part 340 may extend the received method call graph by using the MVC information received through the MVC information reception part 330. The call graph extended through the call graph extension part 340 may be again provided to the code analysis part 310. The code analysis part 310 may analyze the source code of the application program for which the MVC pattern is used by using the extended call graph.

The code analysis part 310 according to the present disclosure may also perform functions of syntax analysis, defect detection, generation of a correction example, and transmission of analysis results. Specifically, the code analysis part 310 may extract and refine various information necessary for analysis from the input source code through the syntax analysis function. Here, the information necessary for analysis may be, for example, the number of lines of an abstract syntax tree or source code, defect position information, and the like.

The code analysis part 310 may also detect information on defects that may be problems in the source code based on the information necessary for analysis, which is refined through the syntax analysis. The information on defects may include, for example, position information such as a file name of a source code and a line in the source code in which a defect actually occurs, a kind of the defect, an actual part causing the defect, and actual defect information such as a flow of the source code in which the defect occurs.

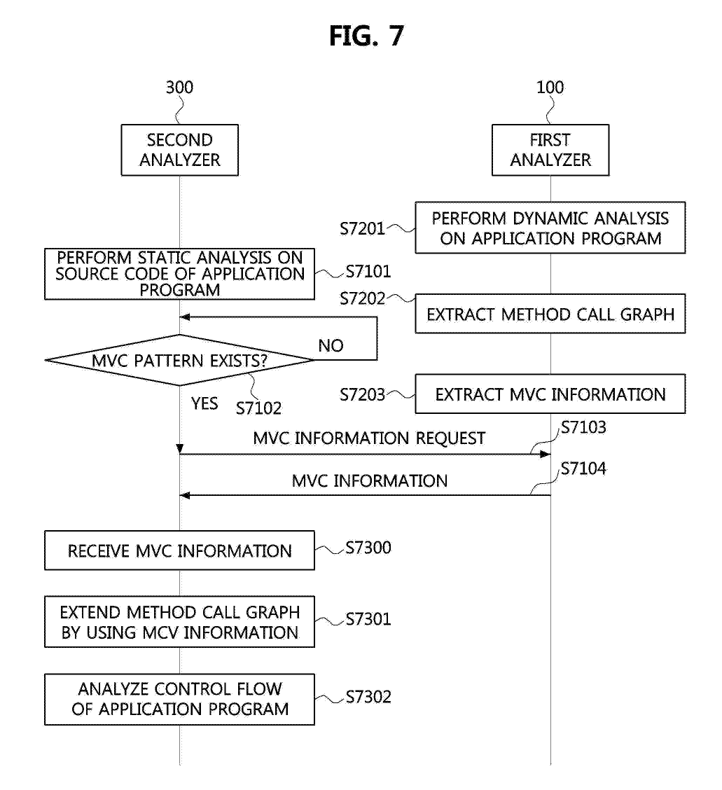

FIG. 7 is a sequence chart for explaining an application program analysis method according to an embodiment of the present disclosure.

An application program analysis method according to an embodiment of the present disclosure may be largely performed by using the first analyzer 100 and the second analyzer 300 as its operation main entities.

A preferred embodiment of the first analyzer may be the dynamic analyzer, and a preferred embodiment of the second analyzer may be the static analyzer.

In the application program analysis method according to the present disclosure, a step 7101 of static analysis on a source code of the application program, a step S7201 of dynamic analysis on the application program, a step S7202 of deriving a method call graph, and a step S7203 of extracting MVC information may be performed prior to other steps to be described later.

When a MVC pattern exists in the application program (S7102), the second analyzer 300 that has performed the static analysis on the source code may request MVC information from the first analyzer (S7103).

There is no need to determine a performing order between S7101 and S7201 to S7203. However, it may be preferable that the steps S7201 to S7203 are completed before the MVC information is requested by the second analyzer 300. Depending on the implementation, the order in which the step S7203 is performed after receiving the MVC information request from the second analyzer 300 may be also possible.

Here, the step S7203 of extracting the MVC information may include, in detail, a step of recognizing the MVC pattern included in the method call graph and a step of identifying the controller methods and view methods called from the dispatcher servlet within the recognized MVC pattern.

The first analyzer 100 receiving the request of the MVC information from the second analyzer 300 may return the MVC information extracted from the method call graph (S7204).

In the embodiment of FIG. 7, the step S7203 of extracting the MVC information from the method call graph is performed by the first analyzer 100. However, as described above with reference to another embodiment of the present disclosure, the MVC information extraction may also be implemented by a separate server, or by the second analyzer 300 or other device.

When the second analyzer 300 receives the MVC information (S7300), the call graph may be expanded using the received MVC information (S7301), and the control flow of the application program may be analyzed using the expanded call graph (S7302).

The application program analysis method according to the present embodiment may further comprise a step of analyzing the source code and the control flow of the application program to generate analysis information.

The methods according to forms of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the operation of the present disclosure, and vice versa.

While the embodiments of the present disclosure and their advantages have been described in detail above, it should be understood that various changes, substitutions and alterations may be made herein without departing from the scope of the disclosure.

What is claimed is:

1. An application program analysis apparatus comprising:
a first analyzer performing a dynamic analysis on an application program and extracting a method call graph;
a model-view-controller (MVC) information extractor extracting MVC information from the method call graph; and
a second analyzer generating an extended call graph by extending the method call graph based on the MVC information, the extended call graph being applied to an analysis of a source code of the application program.

2. The application program analysis apparatus according to claim 1, wherein the MVC information includes information on controller-view relationship.

3. The application program analysis apparatus according to claim 1, wherein the second analyzer uses the extended call graph to analyze a control flow of the application program.

4. The application program analysis apparatus according to claim 1, wherein the first analyzer is a dynamic analyzer.

5. The application program analysis apparatus according to claim 1, wherein the second analyzer is a static analyzer.

6. The application program analysis apparatus according to claim 1, wherein the second analyzer comprises:
a code analysis part generating analysis information by analyzing the source code of the application program; and
a method call graph extension part extending the method call graph by using the MVC information.

7. The application program analysis apparatus according to claim 2, wherein the MVC information extractor recognizes a MVC pattern from the method call graph, and identifies controller methods and view methods called by a dispatcher servlet in the recognized MVC pattern.

8. The application program analysis apparatus according to claim 1, wherein the MVC pattern is implemented using Spring or Struts framework library.

9. An application program analysis method comprising:
performing a dynamic analysis on an application program and extracting a method call graph;
extracting MVC information from the method call graph; and
generating an extended call graph by extending the method call graph based on the MVC information, the extended call graph being applied to an analysis of a source code of the application program.

10. The application program analysis method according to claim 9, wherein the MVC information includes information on controller-view relationship.

11. The application program analysis method according to claim 9, further comprising analyzing a control flow of the application program by using the extended call graph.

12. The application program analysis method according to claim 9, further comprising generating analysis information by analyzing the source code and control flow of the application program.

13. The application program analysis method according to claim 9, wherein the extracting MCV information comprises:
recognizing a MVC pattern from the method call graph; and
identifying controller methods and view methods called by a dispatcher servlet in the recognized MVC pattern.

14. The application program analysis method according to claim 13, wherein the MVC pattern is implemented using Spring or Struts framework library.
